(19) United States
(12) Patent Application Publication
(10) Pub. No.: US 2003/0149598 A1
(43) Pub. Date: Aug. 7, 2003

(54) Intelligent assignment, scheduling and notification scheme for task management

(76) Inventors: Nugroho Iwan Santoso, Plainsboro, NJ (US); David Rapaport, Marlboro, NJ (US)

Correspondence Address: Siemens Corporation, Intellectual Property Department, 170 Wood Avenue South, Iselin, NJ, 08830, US

(21) Appl. No.: 10/351,723

(22) Filed: Jan. 27, 2003

Related U.S. Application Data
(60) Provisional application No. 60/352,444, filed on Jan. 28, 2002.

(51) Int. Cl. G06F 17/60

(52) U.S. Cl. 705/2; 705/9

(57) ABSTRACT

A system and method for intelligent assignment, scheduling and notification for better patient management is provided. The method includes registering at least one clinician along with a schedule of predetermined tasks and availability for the at least one clinician; registering at least one patient; assigning registered patients to the at least one registered clinician; generating an event task for the at least one registered clinician; determining if the at least one clinician is available; and if the at least one clinician is unavailable, assigning the event task to a next available registered clinician. The system will automatically route the event task, e.g., an alarm, with necessary information to a wireless device worn by the responsible clinician. Alarms could be generated by medical equipment, a medication and task scheduler, a central monitoring system, or triggered by abnormal test results.

### PRIORITY

This application claims priority to an application entitled “INTELLIGENT ASSIGNMENT SCHEME FOR MONITORING TASKS” filed in the United States Patent and Trademark Office on Jan. 28, 2002 and assigned Ser. No. 60/352,444, the contents of which are hereby incorporated by reference.

### BACKGROUND OF THE INVENTION

1. Field of the Invention

The present invention relates generally to computer monitoring systems, and more particularly, to a system and method for scheduling and managing tasks in response to event tasks, e.g., alarms, for improved patient management.

2. Description of the Related Art

In the medical domain, evidences of increased personnel response time to alarms due to multiple task assignments and conflicts are on the rise. With continuous shifts between clinicians and increasing number of patients handled by each clinician, the delay in response time to administer the appropriate action/intervention increases. A scheme is needed to automatically assign tasks and resources, resolve the conflicts and signal the responsible person of a task or alarm independent of his/her location.

### SUMMARY OF THE INVENTION

A system and method for intelligent assignment, scheduling and notification for better patient management is provided. In the system and method of the present invention, a scheduling and alerting scheme for clinicians on duty is provided to improve the efficiency and accuracy of patient monitoring/management through automating related scheduling tasks. Efficient assignment can be done following a predefined scheme such as learning-based, rule-based, on-line optimization, or manually by an expert. In a hospital environment, the clinicians on duty can simply use his/her card or id-number with a combination of his/her password to register, and the system can automatically assigns particular patients to the registering clinicians. In the event an event task, e.g., an alarm, is generated, the system and method will automatically route the alarm with the necessary information to a wireless device(s) worn by the responsible clinician(s). Alarms could be generated by medical equipment, a medication and task scheduler, a central monitoring system, or triggered by abnormal test results. This scheme is also extendable to remote environments where the patients and clinicians are not at the same locations (e.g., telemonitoring a patient from their home).

According to one aspect of the present invention, a method for managing tasks is provided. The method includes the steps of registering at least one clinician along with a schedule of predetermined tasks and availability for the at least one clinician; registering at least one patient; assigning registered patients to the at least one registered clinician; generating an event task for the at least one registered clinician; determining if the at least one clinician is available; and if the at least one clinician is unavailable, assigning the event task to a next available registered clinician. The method further includes the step of assigning a risk level to the at least one patient.

According to another aspect, the method further includes the step of assigning priority levels to the predetermined tasks; determining if the priority level of the predetermined task the at least one clinician is performing is greater than a priority level threshold; and if the priority level of the predetermined task is less than the threshold, waiting a predetermined time period and, if the priority level of the predetermined task is greater than the threshold, determining the at least one registered clinician is unavailable.

The assigning step may be learning-based, rule-based, efficiency optimization-based or manual.

The generating an event task step may be initiated by a monitoring device, a maintenance task, or abnormal test results.

According to a further aspect of the present invention, the assigning step of the method includes wirelessly transmitting the event task to the at least one registered clinician.

According to still another aspect of the present invention, the generating an event task step includes generating a test request for at least one patient and generating the event task based on results of the test.

According to another aspect of the present invention, a system for managing tasks includes an task assigner for assigning predetermined tasks to at least one clinician, the predetermined tasks being assigned based on a schedule of the at least one clinician and a plurality of patients; an event-based monitor for generating event tasks; and a transceiver for receiving generated event tasks, the event tasks being assigned by the task assigner based on the clinician's schedule. The transceiver is a mobile device that receives the event tasks wirelessly and transmits data to the task assigner.

According to still a further aspect, the system further includes a registration station for registering the at least one clinician into the system.

The task assigner assigns priority levels to the predetermined tasks and, before assigning the event task to the at least one clinician, determines if the priority level of the predetermined task the at least one clinician is performing is greater than a priority level threshold, and if the priority level of the predetermined task is greater than the threshold, determines the at least one registered clinician is unavailable.

According to another aspect of the present invention, a method for managing tasks includes the steps of registering a plurality of predetermined tasks; registering at least one technician along with a schedule of availability for the at least one technician; assigning registered tasks to the at least one registered technician; generating an event task for the at least one registered technician; determining if the at least one technician is available; and if the at least one technician is unavailable, assigning the event task to a next available registered technician.

### BRIEF DESCRIPTION OF THE DRAWINGS

The above and other aspects, features, and advantages of the present invention will become more apparent in light of the following detailed description when taken in conjunction with the accompanying drawings in which:

FIG. 1 is an information flow diagram for intelligent assignment, scheduling and notification of tasks according to an embodiment of the present invention;

FIG. 2 is an exemplary system for intelligent assignment, scheduling and notification of tasks according to an embodiment of the present invention;

FIG. 3 is a flow chart illustrating a method for intelligent assignment, scheduling and notification of tasks according to an embodiment of the present invention; and

FIG. 4 is an exemplary system for intelligent assignment, scheduling and notification of tasks according to another embodiment of the present invention.

### DETAILED DESCRIPTION OF PREFERRED EMBODIMENTS

Preferred embodiments of the present invention will be described herein below with reference to the accompanying drawings. In the following description, well-known functions or constructions are not described in detail to avoid obscuring the invention in unnecessary detail.

Modern health-care organizations need to operate more efficient than ever to maintain competitiveness. With increasing number of patients who are assigned to each clinician, it is important to implement a strategy and mechanism to effectively assign patients to the clinicians on duty. The system and method according to various embodiments of the present invention will eliminate the confusion about who is responsible for whom, that often occurs due unclear or lack of assignment and transfer process among clinicians. The monitoring systems will remotely alert the responsible party by sending a notification with the necessary information to the responsible person through a personal wireless device, e.g., a mobile transceiver, since each clinician is also occupied with many other tasks which most of the time prevent him/her to be at a main monitoring system or bedside of a patient. In the case that the particular clinicians are engaged in other high priority events, automatic re-assignment will be done, and another clinician will be alerted. Initiated by an event task or alarm, the system will efficiently schedule normal procedures/test (e.g. lab-test, radiology procedure, etc.) as well as alerting the responsible clinicians for scheduled tasks (e.g. medication, EKG readings, blood pressure readings, etc.).

The scheme of the present invention can be also easily adapted for telemonitoring tasks (such as in a nursing home) where high-risk patients can be connected to a portable client monitoring unit which under abnormal conditions will send out alarms to a central monitoring system which in turn will alert the appropriate clinicians. Initial information could be as short as the patient name/id, however, the responsible clinicians can further request additional information from the client monitoring unit through the central monitoring system.

The intelligent assignment, scheduling and notification system in accordance with the present invention will improve the response time of the clinicians in responding to events. It will clarify who is responsible for whom, and alert the appropriate person when an alarm occurs. This will prevent unnecessary delay/error which may classify as the liability of the health organizations. Since significant alarms only happen at a small fraction of the time, the scheme will allow clinicians on duty to do many other tasks while monitoring his/her patients. This will improve the efficiency and productivity of the clinicians which also means reduced operating costs for the organization. Its ability to intelligently schedule the necessary procedure(s)/test(s) after an event occurs (and before a clinicians see the patient) and alert the clinicians for scheduled tasks will significantly reduce the waiting time, reduce error and improve efficiency.

Schemes and Approaches

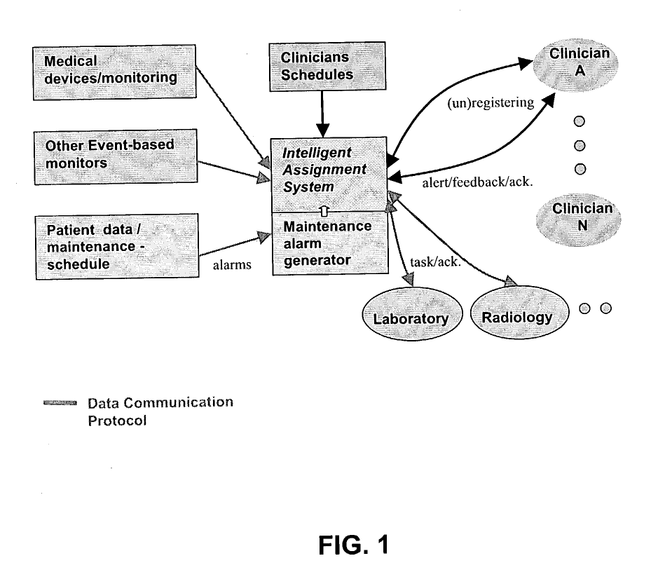

The scheme of the systems and methods of the present invention are to efficiently assign patients to on-duty clinicians, e.g., nurses, physicians, etc., resolve conflicts, and alert the responsible clinicians when an alarm is generated. The definition of an event task may include alarms from patient medical/monitoring devices, maintenance alarms such as medication and procedure alarms, and other event-notification alarms (e.g. lab result availability and criticality, or alarms from voice and position detection). FIG. 1 illustrates generally information flow in the scheduling scheme.

This scheme can be implemented locally in a particular location (e.g., in hospitals) or in distributed environments where the patients are not at the same location as the clinicians. It can be implemented as a module which reside at the central monitoring system or at different system. In an open system environment, communications between modules residing at various systems/computers can be handled efficiently using new or existing data communication protocol.

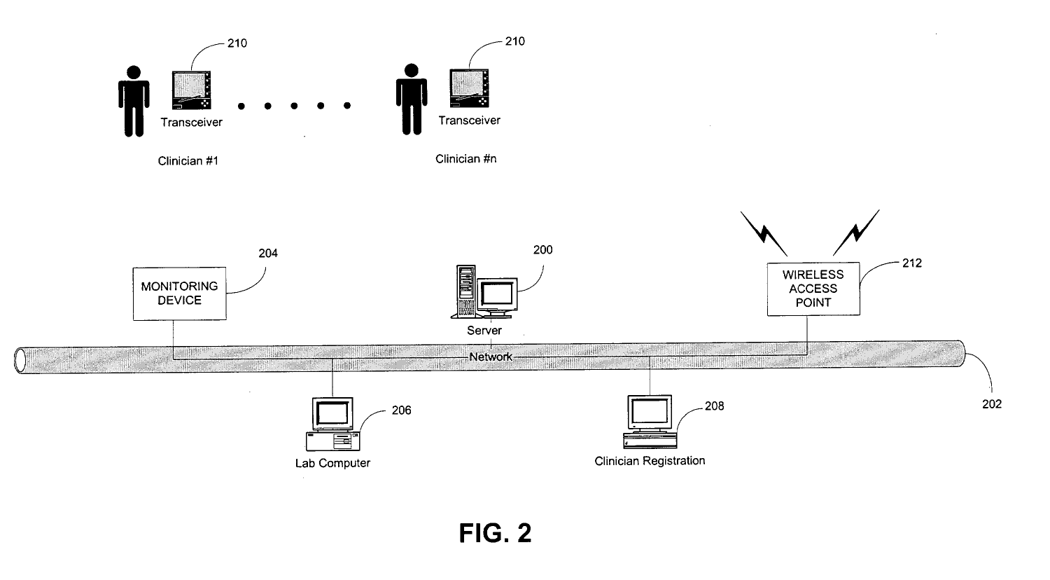

FIG. 2 illustrates an exemplary system for scheduling and managing tasks according to an embodiment of the present invention. The system 200 includes server 200 for assigning clinicians to patients, scheduling tasks, assigning events and notifying clinicians of alarms and network 202 for coupling to the server 200 various devices either hardwired or wirelessly. The above-mentioned processes carried out by the server 200 may be performed by software modules residing in the server 200, e.g., a maintenance alarm generator as shown in FIG. 1. Various patient monitoring devices 204 will be coupled to the network for sending vital statistics or alarms to the server 200. Other hospital systems, e.g., a lab computer 206, may be coupled to the network for sending lab or examination results to the server 200. Optionally, a clinician registration station 208 may be coupled to the network for clinicians to register and unregister from the system. A clinician may register by simply typing in an id/password, sliding an id card through a card reader or by submitting to a biometric identification device.

Each clinician will be assigned a mobile transceiver 210 during their shift. The transceiver 210 will be a two-way communication device for receiving tasks, instructions, and alarms and for sending acknowledgements, status, recorded patient measurements, etc. The transceiver 210 will be coupled to the system wirelessly via any known wireless networking protocol, such as Bluetooth™, IrDA, SWAP, Wi-Fi, etc. The server will employ a wireless networking card to interact with the transceivers and, optionally, the system may employ wireless access points 212 to extend the range of the system.

It is to be understood that a plurality of servers may be coupled to the network 202 to provide multiple monitoring stations for a clinician to review material. For example, upon a task being sent to a clinician, necessary supporting information will be sent together with an alarm or alert to the mobile transceiver. Due to limitations of the transceiver or its display, only a limited amount of supporting information may be sent to the clinician. If necessary, the clinician may access the complete information to perform the task, for example, full size CT images, MR images, patient charts, etc., at any server 200.

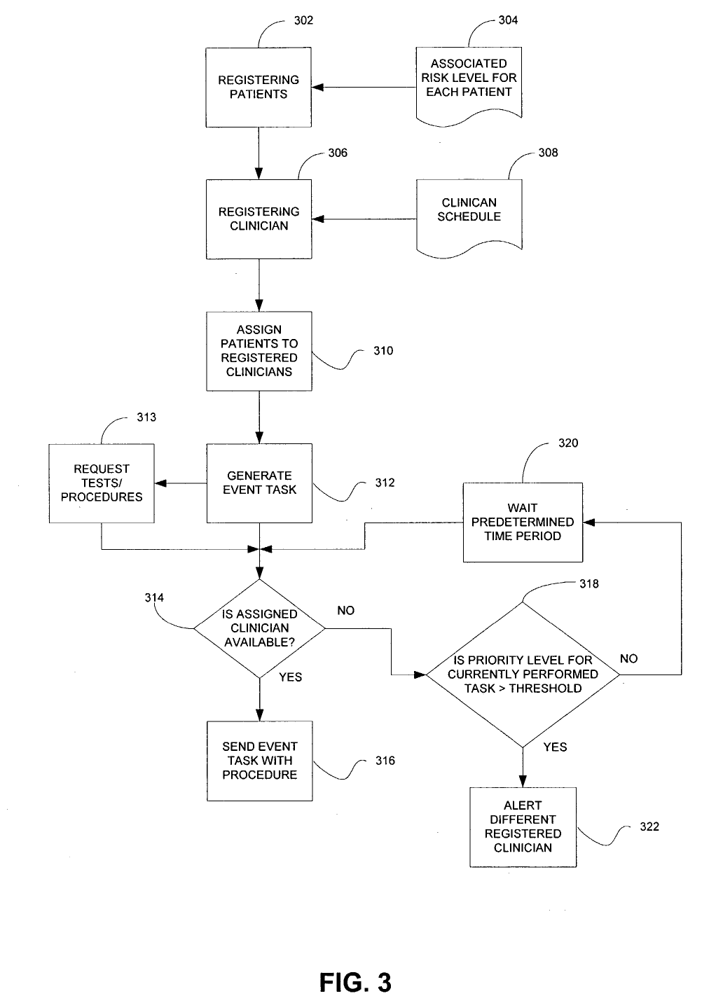

A method according to an embodiment of the present invention that will be implement by the above-described system will be described in relation to FIG. 3.

Assignment Process

The assignment process includes registering/unregistering patients who need to be monitored (step 302), registering/unregistering clinicians on-duty (step 306), and automatic assignment of patients to registered clinicians (step 310). Depending on the initial conditions of the patients, different risk level may be assigned to each patient (step 304). This information can be used to categorize patients into groups where a lower risk group will have higher clinician/patient ratio and lower ratio for the higher risk groups.

Although the assignment process can utilize the available work schedule of a registered clinician, it is only useful to consider clinicians who are actually available at any given period when assigning event tasks. During the registration process, the clinician will register his/her availability by inputting his/her id card(or number) and password (step 308). The system will automatically redistribute the task accordingly and assign patients to the registering clinicians (step 310).

It is to be understood that more than one clinician, e.g., a nurse and a physician, may be assigned to one or more of the same patients during a particular shift or to respond to a particular event task.

Assignment Scheme

The assignment scheme will be responsible in deciding who is responsible for whom. Efficient assignment can be very complicated. Scheduling schemes may include (but not limited to):

(a) Learning-Based.

The system should learn automatically from the history of how an expert distributes the tasks among clinicians depending on the skills and work schedule of the available clinicians, the risk factor of each patient, management schedule for each patient, etc. Various learning techniques are available for in the prior art.

(b) Rule-Based

In this scheme, the assignment follows a certain prespecified set of rules which deemed to be optimal for various conditions. For example, the latest registering clinician will always responsible for new incoming patients and patients of the next outgoing clinician. The rules can be quite complicated depending on the expected efficiency.

(c) On-line Optimization

The assignment process can also be formulated as a constrained-optimization problem where optimal efficiency is the objective function. Optimization can be done on-line with respect to each unique situation. This approach may also be able to offer suggestions whether the system is under or over-staffed.

(d) Manual

A manual assignment feature will be provided as a way to input expert knowledge and override the current automatic assignment.

Alerting Process

The alerting process includes taking the current assignment and sending the appropriate event task or alarm signal/data from the monitoring system to the responsible clinician(s)/person(s) (step 312). In the case where a conflict is found, it should solve the conflict before sending the alarm. The wireless system will allow two-way communication for inputting the status of a task from the clinician to the main monitoring system to inform the system of the availability of the clinician.

Based on the current assignment chart and status, the system will determine if the assigned clinician is available and route the alarm accordingly, or if conflict (e.g. the responsible person is still working on another event) occurs (step 314), then it utilizes the feedback from the clinicians on the assignment status and priority to resolve the conflict. If a clinician is unavailable, the system will determine if the task they are working on is assigned a priority level above a first predetermined threshold (step 318). The system may re-assign the event task to another less busy clinicians (step 322) or keep the original assignment if the alarms are of a lower priority. If the event task generated is of a low priority, the system will wait a predetermine period of time before checking the availability of the clinician (step 320). Alternatively, if the event task generated has a priority level above a second predetermined threshold, the clinician may be alerted to resolve the event task first and then go back to the previously started task. Further, depending on the severity or length of time required to resolve the event task, the previously started task may be reassigned to another clinician. Supporting data, such as medication, procedure needed, bio-data, charts, lab data, etc., should be attached to the alarm or alert, where it could be read at the transceiver, which will expedite decision making.

Two-way wireless communication will allow clinicians to acknowledge receiving the alarm, update the status of the task, change priority, or input other standard feedback (e.g. code blue) to the system. The wireless feature allows the responsible person to do multiple tasks at any given time.

Scheduling Tasks

In certain cases, it is necessary to have particular test(s)/procedure(s) done before a clinician is able to take any action following an alarm. For example, when a event happens, e.g. blood pressure and heart rate of a patient keeps increasing, it is necessary to do some procedures (e.g., measuring vital signs, order blood test to the lab) before the clinician/physician can make decision on what to do next. Therefore, the system will automatically order the procedure before/while (depending on the severity of the alarm) alarming the clinician/physician. The test results may be needed for verifying the alarm itself, or after alarm verification but before any action is taken. Waiting until a physician seeing the patient and prescribing obvious tests is only wasting (critical) time for the sick, not counting the cost of the physician time.

An example of such a scenario is when a patient is diagnosed with unstable asthma under a normal hospital setting. When a pulse-ox meter (SPO2, oxygen saturation meter) generates an alarm of low SPO2, the system will alert the responsible clinician to check the patient. The clinician will probably nebulize the patient to solve the problem. However, if nebulization had happened a few times, e.g., 3 times in the last 6 hours, the systems will automatically issue a request for a blood test checking arterial O2 & CO2 saturation, make arrangements to move the patient to an ICU setting, and alert and send the necessary data (e.g., 3× nebulization with time stamp, blood test data) to a physician such that he/she can make the necessary preparations and trigger the appropriate process.

In this scheme, an alarm (or verification of an alarm) may automatically generate and send orders to do certain test(s)/procedure(s) (step 313); completion of those procedure(s)/test(s) will then trigger the system to send notification to the physician/clinician in charge (step 314). This scheme can also be extended at the triage level, where an initial evaluation of the patient by a nurse generates and sends orders to do test(s)/procedure(s). This approach will reduce the delay time and its corresponding costs existing in the current hospital model.

Hardware

It is to be understood that the present invention may be implemented in various forms of hardware, software, firmware, special purpose processors, or a combination thereof. In one embodiment, the present invention may be implemented in software as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), a read only memory (ROM), input/output (I/O) interface(s) such as a keyboard, cursor control device (e.g., a mouse), and display device. The computer platform also includes an operating system and micro instruction code. The various processes and functions described herein may either be part of the micro instruction code or part of the application program (or a combination thereof) which is executed via the operating system. In addition, various other peripheral devices may be connected to the computer platform such as an additional data storage device and a printing device.

It is to be further understood that, because some of the constituent system components and method steps depicted in the accompanying figures may be implemented in software, the actual connections between the system components (or the process steps) may differ depending upon the manner in which the present invention is programmed. Given the teachings of the present invention provided herein, one of ordinary skill in the related art will be able to contemplate these and similar implementations or configurations of the present invention.

Preferably, the transceiver 210 is embodied in a mobile device such as a personal digital assistant (PDA), text-capable beeper, mobile phone, etc or any other known mobile device capable of receiving/sending text messages and/or images. The transceiver will also include an input device, such as a keyboard, touchscreen, microphone etc, for inputting data and/or acknowledging alarms or tasks and a display.

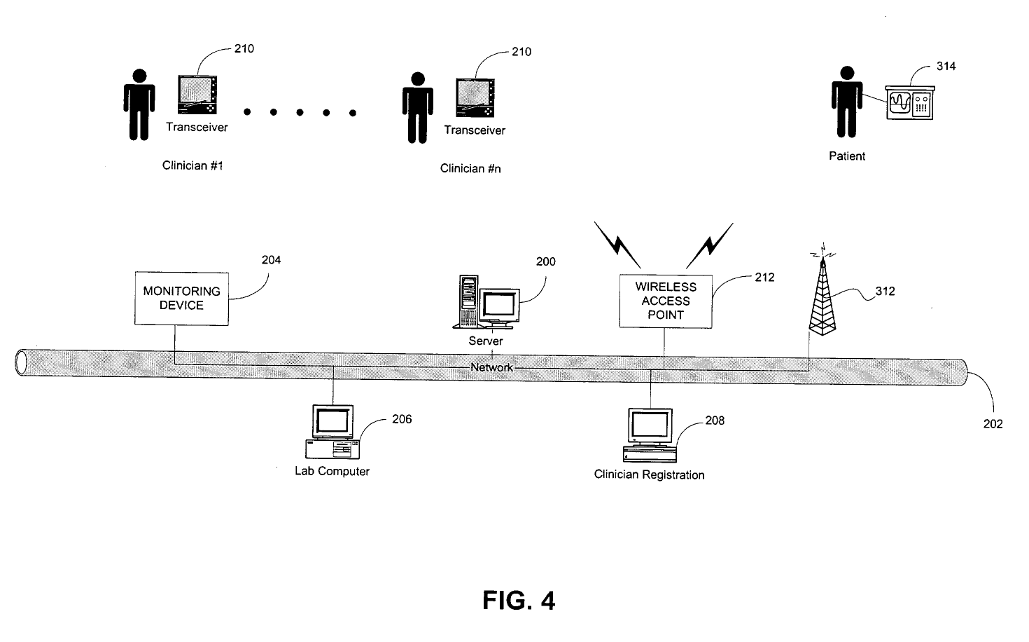

FIG. 4 is an exemplary system for scheduling and managing tasks according to another embodiment of the present invention. Here, the patient and/or clinician is not in the same location, e.g., a hospital, but are in different locations, such as their homes. The system may be coupled to a hardwired telephone network or wireless communications system 312. Here, the patient will be provided with a portable monitoring unit 314 which may be worn or implemented at their home. The transceiver 210 and portable monitoring unit 314 will include a wireless communication module which will be capable of utilizing existing wireless services using standards such as Short Message Service (SMS), General Packet Radio Service (GPRS), Unstructured Supplemental Services Data (USSD), etc. to receive and send information, e.g., tasks and alarms.

An intelligent assignment, scheduling and notification system is described. The systems and methods of the present invention will improve the response time of clinicians in responding to events, e.g., tasks and alarms, by eliminating conflicts/ambiguities and a utilizing two-way wireless alerting scheme. The proposed scheme will better utilize the clinician's time and skill by allowing the person to do multiple tasks while still focusing on the primary tasks, monitoring and responding correctly to alarms as quickly as possible. The scheme will help reduce error by alerting at the appropriate time and providing clinicians with only the necessary information, as well as expedite processes through automatic ordering for medications, tests, and procedures at the appropriate times.

Implementation of this scheme will require various decision support and optimization techniques. In an open system environment, communications between modules residing at various system/computer can be handled efficiently using new or existing data communication protocol, such as SMS OPENLink.

The scheme is applicable not only in the medical domain but also many other domains where scheduling and monitoring tasks exist, such as industrial plants, power system control/plants, computer systems, and building management. For example, in the building management domain, technicians or any appropriate personnel will register into the system and be assigned tasks. In this context, the tasks may be maintenance tasks such as changing light bulbs, changing filters in HVAC equipment, lubricating pumps, etc. An alarm may be generated from a leak in a Mechanical Equipment Room (MER), a freeze alarm or a cold compliant from an occupant of the building. As described above, when an alarm comes in, the system will check the availability of the technician before assigning them the task. Beneficially, the system will transit to the technicians detailed maintenance procedures for performing assigned tasks alleviating them from carrying multiple equipment manuals.

While the invention has been shown and described with reference to certain preferred embodiments thereof, it will be understood by those skilled in the art that various changes in form and detail may be made therein without departing from the spirit and scope of the invention as defined by the appended claims.

What is claimed is:

1. A method for managing tasks, the method comprising the steps of:
registering at least one clinician along with a schedule of predetermined tasks and availability for the at least one clinician;
registering at least one patient;
assigning registered patients to the at least one registered clinician;
generating an event task for the at least one registered clinician;
determining if the at least one clinician is available; and
if the at least one clinician is unavailable, assigning the event task to a next available registered clinician.

2. The method as in claim 1, further comprising the step of assigning a risk level to the at least one patient.

3. The method as in claim 1, further comprising the step of assigning priority levels to the predetermined tasks.

4. The method as in claim 3, wherein the determining step further comprises the steps of:
determining if the priority level of the predetermined task the at least one clinician is performing is greater than a priority level threshold; and
if the priority level of the predetermined task is less than the threshold, waiting a predetermined time period and, if the priority level of the predetermined task is greater than the threshold, determining the at least one registered clinician is unavailable.

5. The method as in claim 3, further comprising the step of assigning priority levels to the event task.

6. The method as in claim 5, wherein the determining step further comprises the steps of:
determining if the priority level of the event task is greater than a priority level threshold; and
if the priority level of the event task is less than the threshold, waiting a predetermined time period and, if the priority level of the event task is greater than the threshold, assigning the event task to the clinician and reassigning at least one of the clinician's predetermined tasks to another clinician.

7. The method as in claim 1, wherein the assigning step is learning-based, rule-based, efficiency optimization-based or manual.

8. The method as in claim 1, wherein the generating an event task step is initiated by a monitoring device.

9. The method as in claim 1, wherein the generating an event task step is initiated by a maintenance task.

10. The method as in claim 1, wherein the generating an event task step is initiated by abnormal test results.

11. The method as in claim 1, wherein the assigning step includes wirelessly transmitting the event task to the at least one registered clinician.

12. The method as in claim 1, wherein the assigning step includes sending supporting data for completing the assigned task.

13. The method as in claim 1, wherein the generating an event task includes generating a test request for at least one patient and generating the event task based on results of the test.

14. The method as in claim 1, further comprising the step of acknowledging the assigned event task by the at least one clinician.

15. A system for managing tasks comprising:
an task assigner for assigning predetermined tasks to at least one clinician, the predetermined tasks being assigned based on a schedule of the at least one clinician and a plurality of patients;
an event-based monitor for generating event tasks; and
a transceiver for receiving generated event tasks, the event tasks being assigned by the task assigner based on the clinician's schedule.

16. The system as in claim 15, wherein the event task includes supporting data for completing the event task.

17. The system as in claim 15, wherein the transceiver is a mobile device and receives the event tasks wirelessly.

18. The system as in claim 17, wherein the transceiver wirelessly transmits data to the task assigner.

19. The system as in claim 15, further comprising a registration station for registering the at least one clinician into the system.

20. The system as in claim 15, wherein the event task is initiated by a medical monitoring device.

21. The system as in claim 15, wherein the event task is initiated by a maintenance task.

22. The system as in claim 15, wherein the event task is initiated by abnormal test results.

23. The system as in claim 15, wherein the task assigner assigns priority levels to the predetermined tasks and, before assigning the event task to the at least one clinician, determines if the priority level of the predetermined task the at least one clinician is performing is greater than a priority level threshold, and if the priority level of the predetermined task is greater than the threshold, determines the at least one registered clinician is unavailable.

24. The system as in claim 23, wherein the task assigner assigns the event task to a next available clinician.

25. The system as in claim 15, wherein the task assigner assigns priority levels to the event task and, before assigning the event task to the at least one clinician, determines if the priority level of the event task is greater than a priority level threshold, and if the priority level of the event task is greater than the threshold, assigns the event task to the at least one clinician and reassigns at least one predetermined task to another clinician.

26. A program storage device readable by a machine, tangibly embodying a program of instructions executable by the machine to perform method steps for managing tasks, the method steps comprising:
registering at least one clinician along with a schedule of predetermined tasks and availability for the at least one clinician;
registering at least one patient;
assigning registered patients to the at least one registered clinician;
generating an event task for the at least one registered clinician;
determining if the at least one clinician is available; and
if the at least one clinician is unavailable, assigning the event task to a next available registered clinician.

27. A method for managing tasks, the method comprising the steps of:
registering a plurality of predetermined tasks,
registering at least one technician along with a schedule of availability for the at least one technician;
assigning registered tasks to the at least one registered technician;
generating an event task for the at least one registered technician;
determining if the at least one technician is available; and
if the at least one technician is unavailable, assigning the event task to a next available registered technician.
